(19) United States
(12) Patent Application Publication
(10) Pub. No.: US 2026/0107882 A1
(43) Pub. Date: Apr. 23, 2026

(54) TOMATO LEAF REMOVAL ROBOT FOR FACILITIES AND LEAF REMOVAL METHOD

(71) Applicant: Shandong Agricultural University, Tai'an City (CN)

(72) Inventors: Tianhua LI, Tai'an City (CN); Yabo LIU, Tai'an City (CN); Guoying SHI, Tai'an City (CN); Min WEI, Tai'an City (CN); Guanshan ZHANG, Tai'an City (CN); Yang LI, Tai'an City (CN); Fei QI, Tai'an City (CN); Xiaoming DING, Tai'an City (CN)

(21) Appl. No.: 19/237,870

(22) Filed: Jun. 13, 2025

(30) Foreign Application Priority Data
Oct. 17, 2024 (CN) 202411448435.2

(51) Int. Cl. A01G 3/08; B25J 11/00

(52) U.S. Cl. CPC A01G 3/08; B25J 11/0055

(57) ABSTRACT

A tomato leaf removal robot for facilities and a leaf removal method are provided. The robot includes a walking body for walking, a depth camera mounted on the walking body and configured to identify and position to-be-pruned foliage; a rotation support body capable of rotation from side to side and connected to the walking body; a telescopic arm base capable of swinging up and down and connected to the rotation support body; a telescopic shaft mounted on the telescopic arm base; a cutting device mounted at a front end of the telescopic shaft; and a collecting frame mounted on the walking body. The robot also includes a disinfection device configured to disinfect a cutting blade and a pruning cut.

### CROSS-REFERENCE TO RELATED APPLICATION

This patent application claims the benefit and priority of Chinese Patent Application No. 202411448435.2 filed with the China National Intellectual Property Administration on Oct. 17, 2024, the disclosure of which is incorporated by reference herein in its entirety as part of the present application.

### TECHNICAL FIELD

The present disclosure relates to the technical field of agricultural robots, and in particular to a tomato leaf removal robot for facilities and a leaf removal method.

### BACKGROUND

Pruning and leaf removal are indispensable key links in the cultivation of tomato, cucumber, pepper and other fruit and vegetable crops, which runs through the whole growth cycle of the crops. By regularly and scientifically pruning and removing leaves of the plants, the balance between vegetative growth and reproductive growth of the plants can be effectively adjusted, making the growth potential of the plants match the development needs of the fruits, which not only can promote the healthy growth of the fruits, but also can avoid excessive consumption of nutrients on leaves or excessive side branches. Reasonable pruning and leaf removing can also significantly improve the ventilation and lighting conditions between the plants, increase the photosynthetic efficiency, reduce the accumulation of moisture, and then reduce the risk of pests and diseases. By reducing the density of leaves and improving microclimate conditions, the spread of diseases can be suppressed, which is of a great significance for improving the yield of fruits and vegetables and improving the quality of fruits.

However, pruning and leaf removal usually need to be done two or three times a week during the growing period of the crops, which makes the burden of manual operation quite heavy. The current pruning and leaf removal operations primarily rely on manual labor using cutting tools for individual stem treatment, which is not only labor intensive as the workers need to bend over for a long time, but also inefficiency as it is difficult to deal with the crops planted in a large area within a short time. With the rapid development of modern protected agriculture, the area and density of large-scale planting have increased year by year, with rising labor costs and intensifying economic pressures in crop management. In addition, the operation level of manual pruning and leaf removal is uneven, and the experience and technology of the workers have also affected the pruning effect. Improper operations may damage plants or reduce yields. Consequently, establishing an automated and intelligent pruning and leaf removal robotic system has become an urgent requirement for large-scale protected agriculture.

At present, a fruit and vegetable pruning and leaf removal actuator and a pruning robot (patent No. CN112136539A) have appeared, in which in the process of pruning and leaf removal, a stopper is used to prevent a main stem from moving, and then a petiole is detached from the main stem by pulling through rotary motion of a clamping device. Another fruit and vegetable pruning device (patent No. CN114342685A) has been published, in which in the process of pruning and leaf removal, the petioles of the fruit and vegetable are guided to move towards a tool edge through a spiral groove. Both above robots may cause damage to fruit and vegetable seedlings due to pulling action when used for leaf removal. Another fruit and vegetable pruning and leaf removal robot and a leaf removal method (patent No. CN116034753A) have been published, in which two motors are used by a telescopic device to respectively drive a lead screw for primary transmission, which is difficult to ensure the synchronization of the driving of the two motors, and may lead to uncoordinated telescopic movement of a mechanical arm. The length of a primary telescopic mechanism in a retracted state is close to that in an extended state, so it is difficult to achieve longer extension in a limited space, resulting in limited use in a compact space. In addition, the above three types of robots only focus on the functions of pruning and leaf removal, but ignore the disinfection of tools, which may lead to cross-contamination between plants. Meanwhile, the lack of a special collecting device makes the leaves scattered on the ground, which increases the workload of subsequent cleaning.

### SUMMARY

For the disadvantages in the prior art, the present disclosure provides a tomato leaf removal robot for facilities and a leaf removal method.

The present disclosure is achieved through the following technical solutions, and provides a tomato leaf removal robot for facilities, including:
a walking body for walking;
a depth camera, mounted on the walking body and configured to identify and position to-be-pruned foliage;
a rotation support body, capable of rotation from side to side and connected to the walking body;
a telescopic arm base, capable of swing up and down and connected to the rotation support body;
a telescopic shaft, mounted on the telescopic arm base and capable of achieving extension and retraction in a front-back direction;
a cutting device, mounted at a front end of the telescopic shaft and configured to cut foliage; and
a collecting frame, mounted on the walking body and configured to collect the foliage cut by the cutting device.

In some embodiments, the robot further includes a disinfection device. The disinfection device includes a water tank, a water pump, and a disinfection spray head mounted on the cutting device.

In some embodiments, an outlet of the water pump communicates with the disinfection spray head through a retractable spring water hose.

In some embodiments, the cutting device includes a housing fixedly connected to the front end of the telescopic shaft, two gears rotatably connected to the housing and meshed with each other, and two blade support members slidingly connected to the housing along arrangement directions of the two gears; wherein each blade support member is fixedly connected with a cutting blade; the two gears are fixedly connected with a first clamping finger and a second clamping finger, respectively; and each blade support member is fixedly connected with a rack meshed with a corresponding gear; and the cutting device further includes a fourth motor for driving any one of the two gears to rotate.

In some embodiments, the telescopic shaft includes a tubular outer casing, a first telescopic tube slidably fitted within the outer casing in the front-back direction, and a second telescopic tube slidably fitted within the first telescopic tube in the front-back direction. The telescopic shaft further includes a second lead screw, a first lead screw slidably fitted within the second lead screw in the front-back direction, and a third motor for driving the first lead screw to rotate. A rear end of the second lead screw is rotatably connected with a first drive ring fixedly connected to the first telescopic tube, the first drive ring is in threaded connection with the first lead screw, and the second lead screw is in threaded connection with a second drive ring fixedly connected to the second telescopic tube.

In some embodiments, the third motor is configured to drive a rotation platform of a rotation driving platform to rotate, and the first lead screw is connected to the rotation platform.

In some embodiments, the rotation support body is connected to an upper end face of the walking body through a bottom rotation platform, and the telescopic arm base is connected to the rotation support body through a side rotation platform.

In some embodiments, the collecting frame includes an outer plate of the collecting frame located on a side surface of the walking body, a retractable plate in sliding fit with the walking body in a horizontal direction, and a driver for driving the retractable plate to slide horizontally. The outer plate of the collecting frame is fixedly connected to the retractable plate, and elastic cloths are connected between both sides and a lower end of the outer plate of the collecting frame and the walking body.

In some embodiments, walking mechanisms are mounted on both sides at the bottom of the walking body. Each walking mechanism includes a track wheel assembly and a land wheel assembly. The track wheel assembly includes a track driven wheel and a track driving wheel; and the land wheel assembly includes a first universal wheel, a land wheel and a second universal wheel. The track wheel assembly and the land wheel assembly are staggered in a left-right direction, and a lower end of the track wheel assembly is higher than that of the land wheel assembly.

A leaf removal method carried out using a tomato leaf removal robot for facilities includes:
S1, adjusting a height and an angle of the depth camera based on a target working range, unfolding the collecting frame, and starting the walking body to walk;
S2, identifying and positioning foliage through the depth camera, stopping moving when detecting target foliage, and positioning a pruning point of the target foliage;
S3, moving the telescopic shaft and the cutting device to a pruning site by rotating the rotation support body from side to side and swinging the telescopic arm base up and down;
S4, causing a cutting device to be aligned with the to-be-pruned foliage by extension and retraction of the telescopic shaft;
S5, clamping, by the cutting device, foliage to be cut, and cutting off the foliage;
S6, disinfecting a cutting blade and a pruned cut by operation of a water pump of a disinfection device; and
S7, moving the cutting device to a position above the collecting frame by rotating the rotation support body from side to side and swinging the telescopic arm base up and down, and through the extension and retraction of the telescopic shaft, and releasing the cutting device to allow cut old leaves fall into the collecting frame.

The present disclosure has the beneficial effects that:
1. Through identification and positioning, the extension and retraction of a telescopic arm, the pruning by an end effector, the disinfection of a disinfection device and the collection of a collecting frame, the manual labor is replaced, and the plant virus infection can be reduced, which achieves full-automatic pruning and leaf removal of the tomato foliage, and improves the pruning efficiency.
2. The overall volume is small, and a dual-purpose chassis is adopted, and thus the robot can adapt to the pruning operation of fruits and vegetables in different scenes.
3. A height and angle of a depth camera can be adjusted through a camera holder, thus meeting pruning and leaf removal requirements of the tomatoes at different heights.
4. The cut foliage can be placed in the collecting frame through a collecting device, which can replace manual cleaning and improve the pruning and leaf removal efficiency.
5. An end effector is simple in design, and a clamping structure and a cutting blade can be enabled to move towards each other under the driving of a fourth motor.
6. A disinfection device can disinfect the cut site in time at the end of one pruning and leaf removal, thus effectively preventing the plants from virus infection.
7. The disinfection device may move synchronously with a rotation support device and a telescopic device, which can prevent the water hose from winding or knotting, reduce the drag resistance, improve the system reliability and the operation flexibility, and ensure that the disinfection process is smooth and comprehensive. Moreover, a connection between the water tank and the water pump is in a threaded mode, and thus the water tank can be disassembled conveniently for replacing liquid medicine.
8. After the leaf removal and cutting operation is completed, the old leaves are clamped; then, the telescopic device retracts to be pulled back to an original position; at this time, the rotation device turns around, and the telescopic device extends and falls above the collecting frame, and finally, the old leaves fall into the collecting frame, which can greatly reduce a radius of turning around of the telescopic device, thus preventing from damaging other foliage.

### BRIEF DESCRIPTION OF THE DRAWINGS

FIG. 1 is a structural diagram according to the present disclosure;

FIG. 2 is a side view of a walking mechanism according to the present disclosure;

FIG. 3 is a front view of a walking mechanism according to the present disclosure;

FIG. 4 is a structural diagram of a rotation support body and a telescopic arm base according to the present disclosure;

FIG. 5 is a structural diagram of a cutting device according to the present disclosure;

FIG. 6 is a structural diagram of a rotation driving platform according to the present disclosure;

FIG. 7 is a structural diagram of a telescopic shaft according to the present disclosure;

FIG. 8 is a structural diagram of a rotation support body and a telescopic arm base according to the present disclosure from another perspective;

FIG. 9 is a diagram of an internal structure of a telescopic shaft according to the present disclosure;

FIG. 10 is a diagram of a connecting structure of a telescopic shaft and a rotation driving platform according to the present disclosure;

FIG. 11 is a structural diagram of a second drive ring according to the present disclosure;

FIG. 12 is a structural diagram of a first drive ring according to the present disclosure;

FIG. 13 is a diagram of a connecting structure of a first drive ring and a second lead screw according to the present disclosure;

FIG. 14 is a sectional diagram of the connection of a first drive ring and a second lead screw according to the present disclosure;

FIG. 15 is a diagram showing the outside of a first telescopic tube and the inside of a second telescopic tube according to the present disclosure;

FIG. 16 is a structural diagram of a collecting frame according to the present disclosure;

FIG. 17 is a structural diagram of a power supply line of a cutting device according to the present disclosure;

FIG. 18 is a structural diagram of a disinfection device according to the present disclosure;

FIG. 19 is a diagram of a connecting structure of a water pump according to the present disclosure; and

FIG. 20 is a diagram showing three states in the leaf removal process according to the present disclosure.

In the drawings:

1—walking body; 2—control button; 3—camera holder; 4—depth camera; 5—housing; 6—cutting device; 7—outer casing; 71—first telescopic tube; 72—second telescopic tube; 8—rotation driving platform; 9—second motor; 10—rotation support body; 11—first motor; 12—connecting rod; 13—outer plate of collecting frame; 14—track driven wheel; 15—first universal wheel; 16—retractable plate; 17—land wheel; 18—second universal wheel; 19—track driving wheel; 20—telescopic arm base; 21—fourth motor; 22—gear; 23—rack; 24—clamping mechanism; 25—first clamping finger; 26—second clamping finger; 27—blade support member; 28—cutting blade; 29—rotation platform; 30—third motor; 31—first lead screw; 32—second lead screw; 33—sliding key; 34—keyway; 35—driver; 36—to-be-pruned foliage; 37—spiral wire; 38—sleeve; 39—water pump; 40—retractable spring water hose; 41—disinfection spray head; 42—stopper; 43—water tank; 44—elastic cloth; 45—water hose joint; 46—connecting bolt; 47—water inlet; 48—water outlet; 491—first drive ring; 492—second drive ring; 50—plug; 51—guide keyway; 52—guide key; 53—notch; 54—groove; 55—ball.

### DETAILED DESCRIPTION OF THE EMBODIMENTS

To describe the technical features of the solution clearly, the solution is set forth below with reference to specific embodiments.

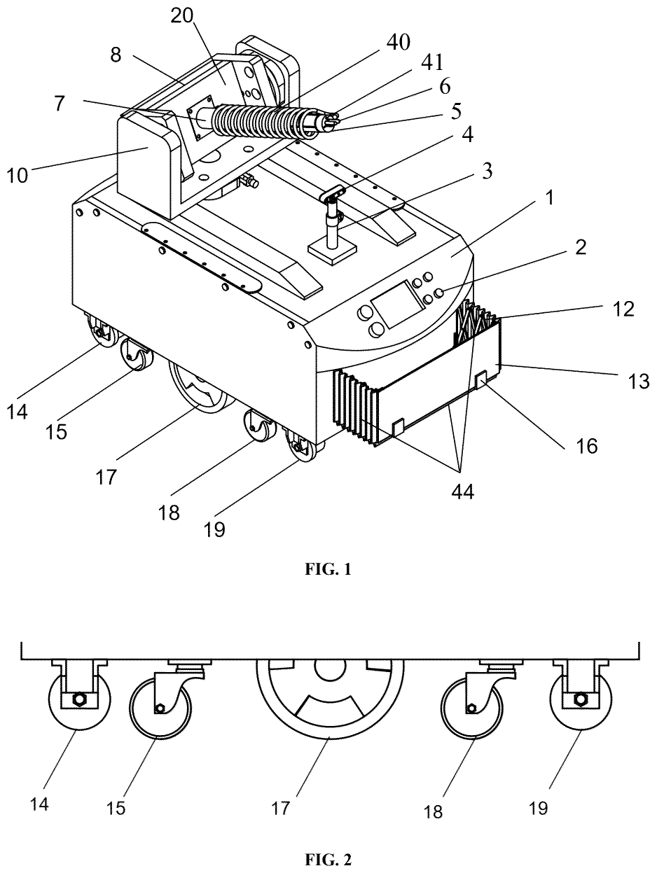

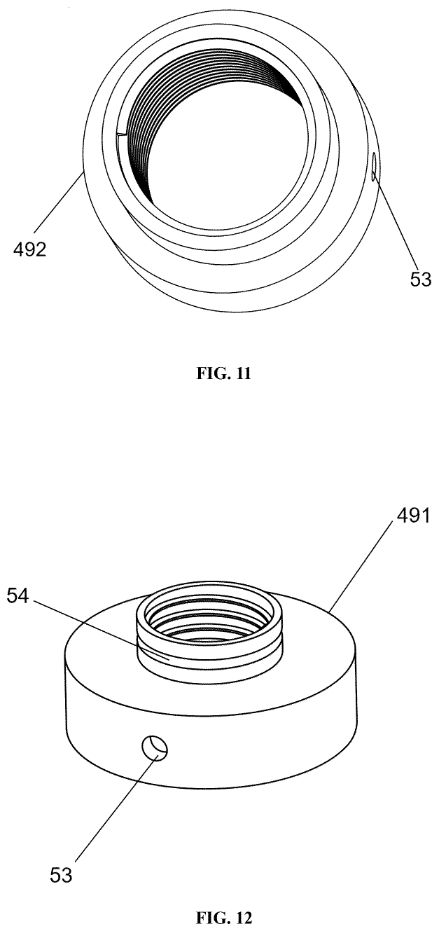

As shown in FIG. 1 to FIG. 20, a tomato leaf removal robot for facilities provided by the present disclosure includes a walking body 1, a rotation support body 10, a telescopic arm base 20, a telescopic shaft, a cutting device, a collecting frame, and a disinfection device.

The walking body 1 is configured to drive the whole robot to walk. A depth camera is configured to identify and position to-be-pruned foliage. The rotation support body can rotate and swing left and right, thus adjusting a left-right position of the cutting device. The telescopic arm base can swing up and down, thus adjusting an up-down position of the cutting device. The telescopic shaft can extend or retract in a front-back direction, thus adjusting a front-back position of the cutting device. The cutting device is configured to cut the foliage, and the collecting frame is configured to collect the foliage cut off by the cutting device.

Each part is introduced in detail below.

Walking mechanisms are mounted on both sides at the bottom of the walking body 1. Each walking mechanism includes a track wheel assembly and a land wheel assembly. The track wheel assembly includes a track driven wheel 14 and a track driving wheel 19. The land wheel assembly includes a first universal wheel 15, a land wheel 17, and a second universal wheel 18. The track wheel assembly and the land wheel assembly are staggered in a left-right direction, and a lower end of the track wheel assembly is higher than that of the land wheel assembly.

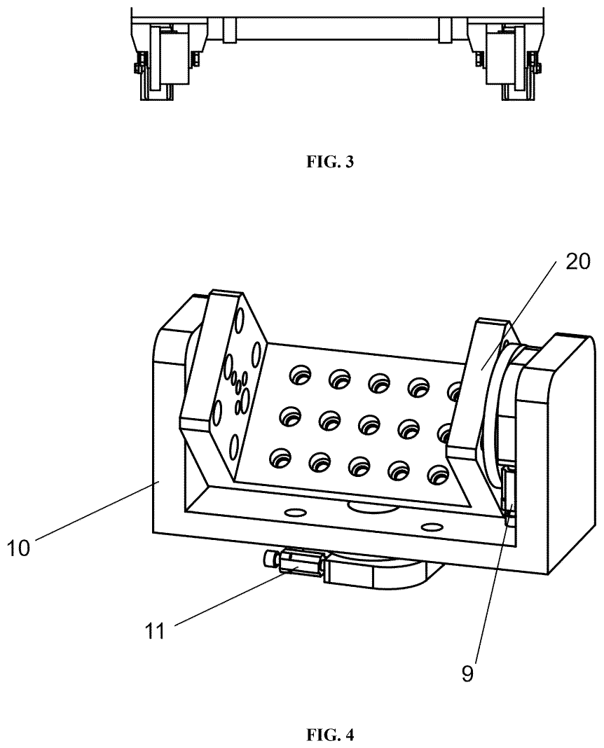

As shown in FIG. 2 and FIG. 3, the track wheel assembly is arranged on an inner side of the walking body 1 relative to the land wheel assembly and located at an upper part with respect to the land wheel assembly. Through the advancement of the land wheel 17 and angle adjustment of the first universal wheel 15 and the second universal wheel 18, the walking body 1 walks to the front of a track, and when the track driving wheel 19 steps on the track, the track driving wheel 19 starts to operate to drive the walking body 1 to get on the track. After the walking body 1 gets on the track completely, the land wheel 17 stops working, and at this time, a walking device works on the track.

The walking body 1 is provided with a control button 2. Before pruning and leaf removal, the walking device is controlled by the control button 2 to move forward and get on the track, thus adapting to the tomato pruning operation in different scenes.

The depth camera 4 is mounted at a front end of the walking body 1 through a camera holder 3, thus avoiding the interference among various devices during working. A height and an angle of the depth camera 4 can be adjusted through the camera holder 3 to meet tomato leaf removal requirements at different heights. The depth camera 3 is configured to identify and position to-be-pruned foliage 36 and determine relative positions of the rotation support body 10, the telescopic arm base 20, the telescopic shaft and the cutting device, thus determining a cutting position and blade orientation of the cutting device. The depth camera in this embodiment is RealSense D435i depth camera.

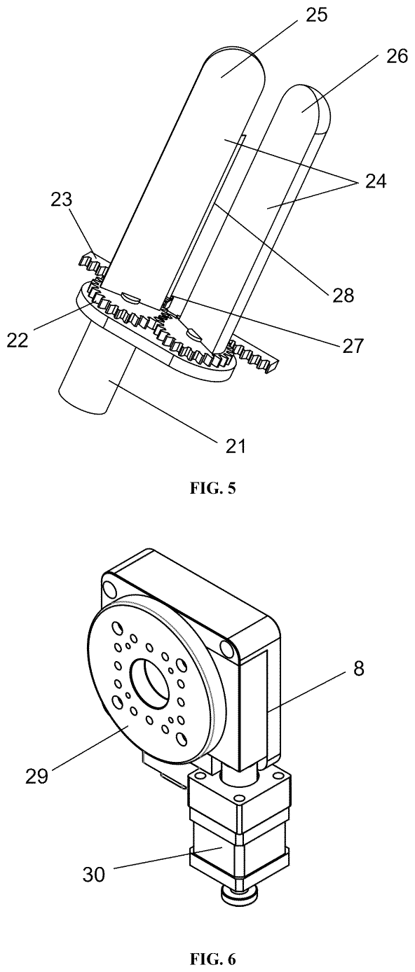

As shown in FIG. 4, the rotation support body 10 is connected to an upper end face of the walking body 1 through a bottom rotation platform, a rotating shaft of the bottom rotation platform is vertically arranged and driven by a first motor 11 to rotate, the telescopic arm base 20 is connected to the rotation support body 10 through a side rotation platform, and a rotating shaft of the side rotation platform is horizontally arranged and driven by a second motor 9 to rotate.

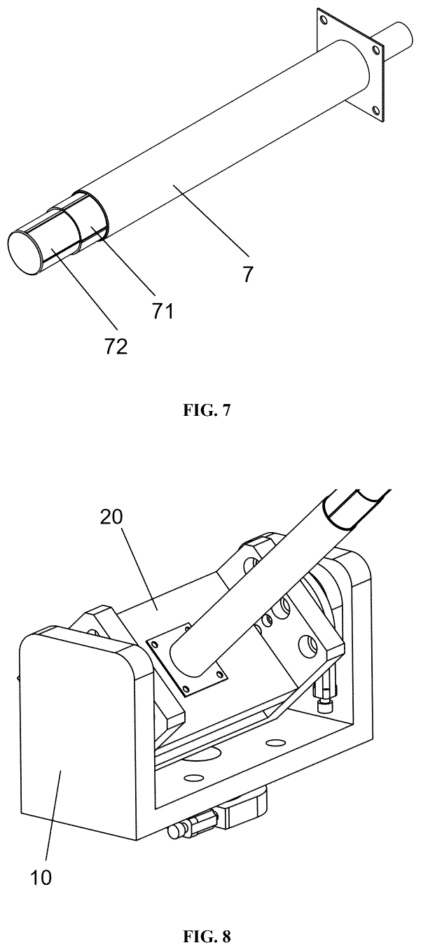

As shown in FIG. 7 to FIG. 15, the telescopic shaft is a two-stage telescopic shaft. The telescopic shaft includes a tubular outer casing 7, a first telescopic tube 71 slidably fitted within the outer casing 7 in a front-back direction, and a second telescopic tube 72 slidably fitted within the first telescopic tube 71 in a front-back direction. A rear end of the outer casing 7 is fixedly connected to the rotation support body 10. As shown in FIG. 14, the front-back guidance between the first telescopic tube 71 and the outer casing 7 is achieved through a sliding key 33 and a keyway 34 to prevent relative rotation, and the front-back guidance between the first telescopic tube 71 and the second telescopic tube 72 is also achieved through a sliding key 33 and a keyway 34 to prevent relative rotation. The cutting device is mounted at a front end of the second telescopic tube 72.

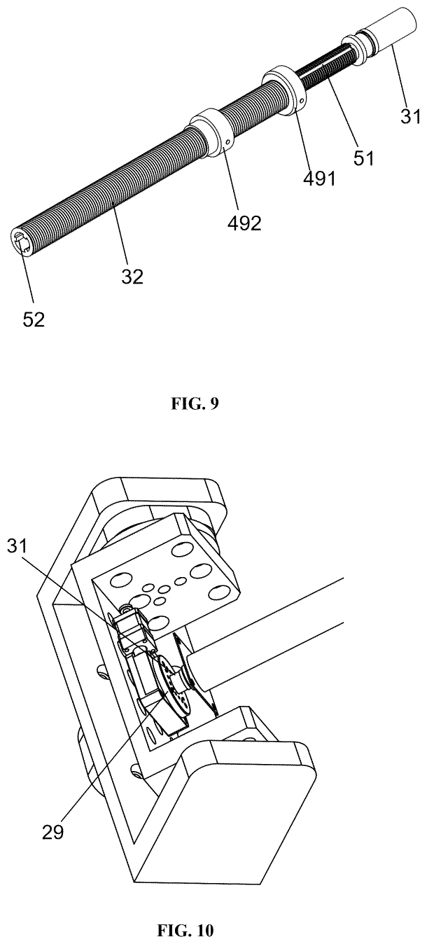

As shown in FIG. 9, the telescopic shaft further includes a second lead screw 32, a first lead screw 31 slidably fitted within the second lead screw 32 in a front-back direction, and a third motor 30 for driving the first lead screw 31 to rotate. An outer side of the first lead screw 31 is provided with a guide keyway 51, an inner side of the second lead screw is provided with a guide key 52, such that the second lead screw 32 can be driven to rotate when the first lead screw 31 rotates, and the first lead screw 31 and the second lead screw 52 can slide back and forth. The third motor 30 is configured to drive a rotation platform 29 of a rotation driving platform 8 to rotate, and the first lead screw 31 is connected to the rotation platform 29, thus driving the first lead screw 31 to rotate.

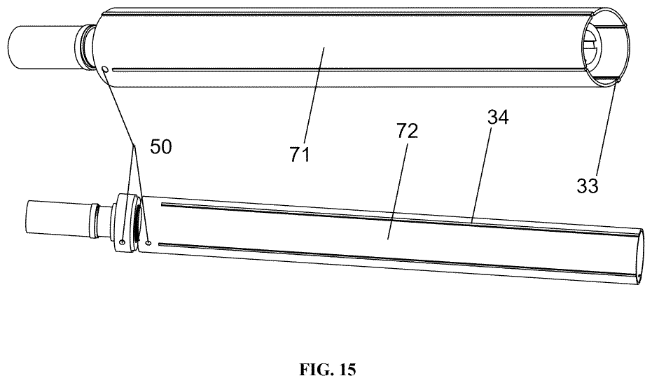

A rear end of the second lead screw 32 is rotatably connected to a first drive ring 491 fixedly connected to the first telescopic tube 71. Separately, the rear end of the second lead screw 32 is rotatably connected to the first drive ring 491, and the first drive ring 491 is fixedly connected to the first telescopic tube 71. The first drive ring 491 is sleeved on an outer ring of the first lead screw 31, and the first drive ring 491 is in threaded connection with the first lead screw 31. As shown in FIG. 12, both sides of the first drive ring 491 are provided with notches 53, and the first drive ring 491 is fixedly connected to the first telescopic tube 71 through a plug 50 in FIG. 15. Therefore, the first drive ring 491 can be driven to move forwards when the first lead screw 31 rotates, thus driving the first telescopic tube 71 to extend forwards.

Meanwhile, as the rear end of the second lead screw 32 is rotatably connected to the first telescopic tube 71, the second lead screw 32 is driven to extend forwards, and certainly, the second lead screw 32 also rotates at the same time.

To achieve the rotary connection between the first drive ring 491 and the rear end of the second lead screw 32, as shown in FIG. 12 and FIG. 13, each of an outer side of the first drive ring 491 and the inside of the second lead screw 32 is provided with a groove 54. The groove 54 is filled with balls 55 to reduce the heat generated by contact friction while achieving rotary connection between the first drive ring 491 and the second lead screw 32.

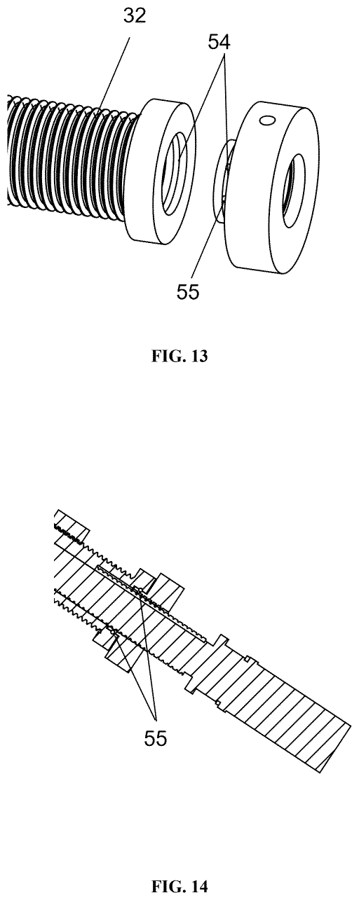

The second drive ring 492 fixedly connected to the second telescopic tube 72 is in threaded connection to the second lead screw 32. As shown in FIG. 11, each of both sides of the second drive ring 492 is provided with a notch 53, the second drive ring 492 is fixedly connected to the second telescopic tube 72 through the plug 50 in FIG. 15, and thus the second lead screw 32, when moving forwards and rotating, can drive the second telescopic tube 72 to move forwards relative to the second lead screw 32, thus achieving two-stage extension and retraction.

As shown in FIG. 17, a power supply line of the cutting device employs a spiral wire 37. An outer casing 7 is located in a sleeve 38, and a sufficient space is left between the outer casing 7 and the sleeve 38, thus ensuring that the power supply operation of the wire is not affected during the extension and retraction of the telescopic shaft.

As shown in FIG. 5, the cutting device includes a housing 5 fixedly connected to a front end of the telescopic shaft, two gears 22 which are rotatably connected to the housing 5 and meshed with each other, and two blade support members 27 slidingly connected to the housing 5 along arrangement directions of the two gears 22. Each blade support member 27 is fixedly connected with a cutting blade 28, and the cutting blade is slender, which is convenient for the blade to enter the tomato foliage for cutting, and can prevent the blade for damaging the tomato foliage during opening and closing of the blade and the positioning.

A first clamping finger 25 and a second clamping finger 26 are fixedly connected to the two gears 22, respectively. The first clamping finger 25 and the second clamping finger 26 form a clamping mechanism. The cutting device further includes a fourth motor 21 for driving any one of the gears 22 to rotate. Each of the first clamping finger 25 and the second clamping finger 26 is eccentrically arranged with respect to the gears. Therefore, when the two gears 22 rotate, the first clamping finger 25 and the second clamping finger 26 are driven to move relative to each other, thus achieving clamping or releasing.

A rack 23 meshed with the gear 22 is fixedly connected to the blade support member 27, and two racks 23 are meshed with the two gears 22, respectively. The racks are driven when the gears are driven by the motor. Under the driving of the fourth motor, the first clamping finger and the second clamping finger can rotate along opposite directions, respectively, and at the same time, the two cutting blades are driven to move oppositely for cutting. It should be noted here that the cutting device 6 shown in this embodiment is mounted in the housing 5, thus forming good protection for the fourth motor 21, the gear assembly 22 and the rack assembly 23, and ensuring the overall aesthetics of an end effector.

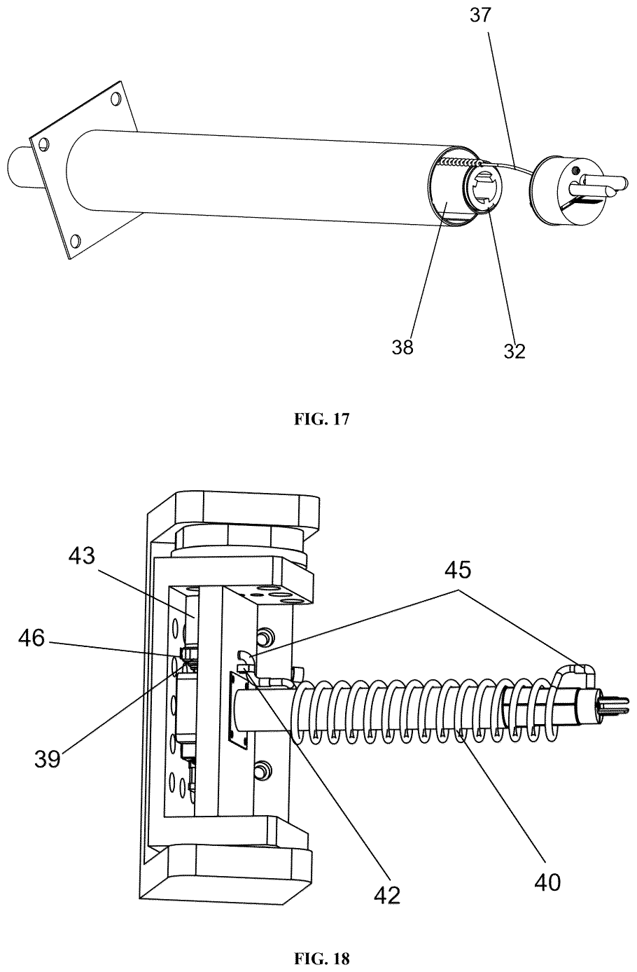

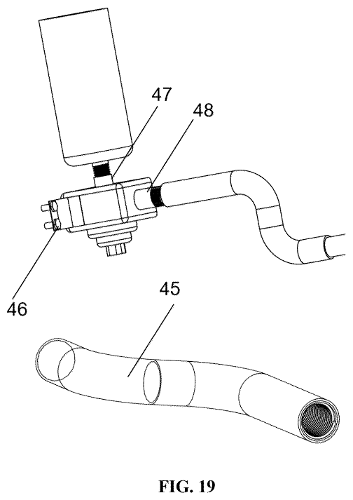

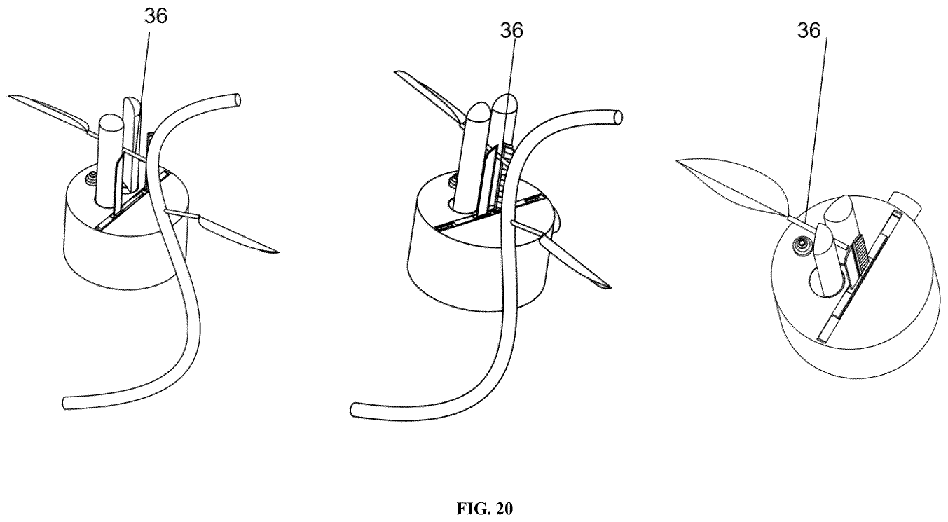

As shown in FIG. 18 and FIG. 19, the disinfection device includes a water tank 43, a water pump 39, and a disinfection spray head 41 mounted on the cutting device. An outlet of the water pump 39 communicates with the disinfection spray head 41 through a retractable spring water hose 40.

The water pump 39 of the disinfection device is mounted on the telescopic arm base 20 through a connecting bolt 46, a water inlet 47 of the water pump is connected to the water tank 43, and a water outlet 48 of the water pump is connected to a water hose joint 45. A stopper 42 is fixedly connected to the telescopic arm base 20, the retractable spring water hose 40 is connected to the water pump 39 and the cutting device by the stopper 42 and the water hose joint 45. The retractable spring water hose is in serpentine distribution along the outer casing 7, and liquid medicine is sprayed through the disinfection spray head 41. The disinfection spray head 41 is mounted on the cutting device and at an upper side of the cutting blade 28 to disinfect the cutting blade and the pruning site in time at the end of pruning, thus effectively avoiding virus infection of vegetable plants.

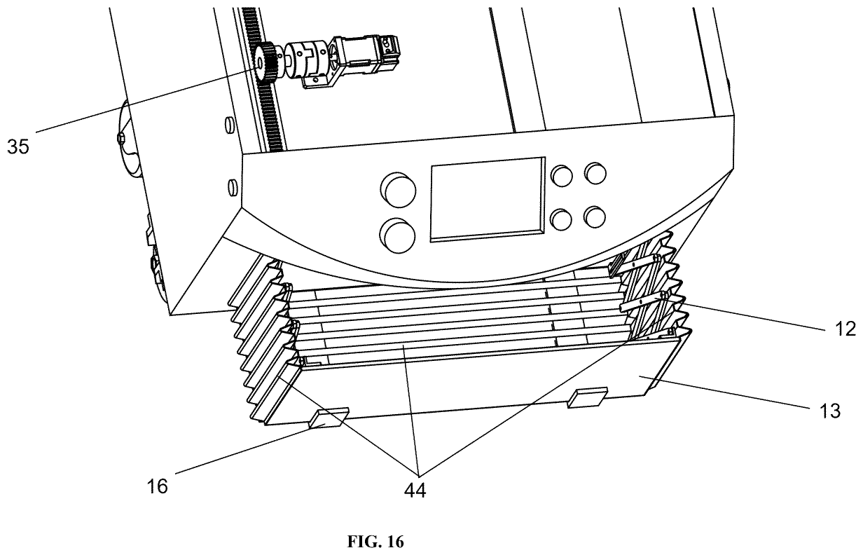

As shown in FIG. 16, the collecting frame includes an outer plate 13 of the collecting frame located on a side surface of the walking body 1, a retractable plate 16 slidingly connected to the walking body 1 in a horizontal direction, and a driver 35 for driving the retractable plate 16 to slide horizontally. The outer plate 13 of the collecting frame is fixedly connected to the retractable plate 16, and elastic cloths 44 are connected between both sides and a lower end of the outer plate 13 of the collecting frame and the walking body 1. Multiple connecting rods 12 are fixedly connected to the elastic cloths 44 to play a role in supporting and preventing deformation.

The driver is configured to achieve the extension and retraction of the collecting frame by driving the retractable plate, and the cut foliage falls into the collecting frame. The driver in this embodiment is a rack-and-gear structure driven by the motor.

In this embodiment, the robot adopts oblique upward extension and retraction during leaf removal, and then carries out a cutting action after reaching a proper position. Such a cutting mode can avoid the collision and damage of the traditional leaf removal mode on fruit and vegetable seedlings, and meanwhile, the cutting mode from bottom to top can avoid the shielding problem of leaves, and thus the machine can quickly find the petiole position.

A leaf removal method carried out using a tomato leaf removal robot for facilities includes the following steps S1-S7.

In step S1, a height and an angle of a depth camera are adjusted based on a target working range, a collecting frame is unfolded, and a walking body is started to walk.

In step S2, foliage is identified and positioned through the depth camera, the robot stops moving when detecting target foliage, and a pruning point of the target foliage is positioned.

In step S3, a rotation support body rotates from side to side, and a telescopic arm base swings up and down, such that a telescopic shaft and a cutting device move to a pruning site.

In step S4, the telescopic shaft extends and retracts to make a cutting device align with to-be-pruned foliage.

When the telescopic shaft extends and retracts, a first lead screw 31 rotates to drive a first drive ring 491 to move forwards, thus driving a first telescopic tube 71 to extend forward. Meanwhile, as a rear end of the second lead screw 32 is rotatably connected to the first telescopic tube 71, a second lead screw 32 is driven to extend forward. And certainly, the second lead screw lead 32 also rotates at the same time. Therefore, when the second lead screw 32 moves forwards and rotates, a second telescopic tube 72 can be driven to move forwards relative to the second lead screw 32 to achieve two-stage extension and retraction.

In step S5, the foliage to be cut is clamped by the cutting device, and the foliage is cut off.

When the cutting device is used for cutting, after the foliage enters a cutting range of the cutting device 6, a fourth motor rotates to make shank support structures move close to each other, to close cutting blades 28 to complete the cutting action. When the fourth motor rotates, a first clamping finger 25 and a second clamping finger 26 of a clamping mechanism 24 can rotate respectively in opposite direction to clamp the cut foliage and prevent the foliage from falling.

In step S6, a water pump of a disinfection device is enabled to operate for disinfecting a cutting blade and a pruned site.

In step S7, the rotation support body rotates from side to side, the telescopic arm base swings up and down, and the telescopic shaft extends and retracts to make the cutting device reach a position above a collecting frame, and the cutting device is released to make the cut old leaves fall into the collecting frame.

When the cutting device is released, the fourth motor rotates, making the first clamping finger 25 and the second clamping finger 26 move in opposite directions.

Through the identification and positioning of tomato foliage, extension and retraction of the telescopic arm, the pruning by the end effector, target disinfection and collection of the collecting frame, the problems of high labor intensity, low efficiency, high labor cost and plant virus infection in the existing manual pruning operation are solved, and the pulling damage to the tomato branches is avoided, thereby reducing the spread of plant diseases and insect pests. Therefore, the full-automatic pruning and leaf removal of the tomato foliage is achieved, and the pruning efficiency is improved.

Certainly, the above description is not limited to the above examples, and the technical features of the present disclosure that have not been described can be implemented by or by using the prior art, and thus will not be repeated here. The above embodiments and accompanying drawings are only used to illustrate rather than limiting the technical solution of the present disclosure. The present disclosure has been described in detail with reference to the preferred embodiments. It should be understood by those of ordinary skill in the art that changes, modifications, additions or substitutions made by those of ordinary skill in the art within the essential scope of the present disclosure without departing from the purpose of the present disclosure also belong to the scope of protection of the claims of the present disclosure.

What is claimed is:

1. A tomato leaf removal robot for facilities, comprising:
a walking body for walking;
a depth camera, mounted on the walking body and configured to identify and position to-be-pruned foliage;
a rotation support body, capable of rotation from side to side and connected to the walking body;
a telescopic arm base, capable of swing up and down and connected to the rotation support body;
a telescopic shaft, mounted on the telescopic arm base and capable of achieving extension and retraction in a front-back direction;
a cutting device, mounted at a front end of the telescopic shaft and configured to cut foliage; and
a collecting frame, mounted on the walking body and configured to collect the foliage cut by the cutting device.

2. The tomato leaf removal robot for facilities according to claim 1, further comprising a disinfection device, wherein the disinfection device comprises a water tank, a water pump, and a disinfection spray head mounted on the cutting device.

3. The tomato leaf removal robot for facilities according to claim 2, wherein an outlet of the water pump communicates with the disinfection spray head through a retractable spring water hose.

4. The tomato leaf removal robot for facilities according to claim 1, wherein the cutting device comprises:
a housing, fixedly connected to the front end of the telescopic shaft;
two gears, rotatably connected to the housing and meshed with each other;
two blade support members, slidingly connected to the housing along arrangement directions of the two gears; and
a fourth motor, for driving any one of the two gears to rotate, wherein
each blade support member is fixedly connected with a cutting blade,
the two gears are fixedly connected with a first clamping finger and a second clamping finger, respectively, and
each blade support member is fixedly connected with a rack meshed with a corresponding gear.

5. The tomato leaf removal robot for facilities according to claim 1, wherein the telescopic shaft comprises:
a tubular outer casing;
a first telescopic tube, slidably fitted within the outer casing in the front-back direction;
a second telescopic tube, slidably fitted within the first telescopic tube in the front-back direction;
a second lead screw;
a first lead screw, slidably fitted within the second lead screw in the front-back direction; and
a third motor, for driving the first lead screw to rotate, wherein
a rear end of the second lead screw is rotatably connected with a first drive ring fixedly connected to the first telescopic tube,
the first drive ring is in threaded connection with the first lead screw, and
the second lead screw is in threaded connection with a second drive ring fixedly connected to the second telescopic tube.

6. The tomato leaf removal robot for facilities according to claim 5, wherein the third motor is configured to drive a rotation platform of a rotation driving platform to rotate, and the first lead screw is connected to the rotation platform.

7. The tomato leaf removal robot for facilities according to claim 1, wherein the rotation support body is connected to an upper end face of the walking body through a bottom rotation platform, and the telescopic arm base is connected to the rotation support body through a side rotation platform.

8. The tomato leaf removal robot for facilities according to claim 1, wherein the collecting frame comprises:
an outer plate of the collecting frame, located on a side surface of the walking body;
a retractable plate, in sliding fit with the walking body in a horizontal direction; and
a driver, for driving the retractable plate to slide horizontally, wherein
the outer plate of the collecting frame is fixedly connected to the retractable plate, and
elastic cloths are connected between both sides and a lower end of the outer plate of the collecting frame and the walking body.

9. The tomato leaf removal robot for facilities according to claim 1, wherein walking mechanisms are mounted on both sides at bottom of the walking body, and each walking mechanism comprises a track wheel assembly and a land wheel assembly; wherein
the track wheel assembly comprises a track driven wheel and a track driving wheel;
the land wheel assembly comprises a first universal wheel, a land wheel and a second universal wheel; and
the track wheel assembly and the land wheel assembly are staggered in a left-right direction, and a lower end of the track wheel assembly is higher than that of the land wheel assembly.

10. A leaf removal method carried out using a tomato leaf removal robot for facilities, wherein
the tomato leaf removal robot for facilities comprises:
a walking body for walking;
a depth camera, mounted on the walking body and configured to identify and position to-be-pruned foliage;
a rotation support body, capable of rotation from side to side and connected to the walking body;
a telescopic arm base, capable of swing up and down and connected to the rotation support body;
a telescopic shaft, mounted on the telescopic arm base and capable of achieving extension and retraction in a front-back direction;
a cutting device, mounted at a front end of the telescopic shaft and configured to cut foliage; and
a collecting frame, mounted on the walking body and configured to collect the foliage cut by the cutting device; and
the leaf removal method comprises:
S1, adjusting a height and an angle of the depth camera based on a target working range, unfolding the collecting frame, and starting the walking body to walk;
S2, identifying and positioning foliage through the depth camera, stopping moving when detecting target foliage, and positioning a pruning point of the target foliage;
S3, moving the telescopic shaft and the cutting device to a pruning site by rotating the rotation support body from side to side and swinging the telescopic arm base up and down;
S4, causing a cutting device to be aligned with the to-be-pruned foliage by extension and retraction of the telescopic shaft;
S5, clamping, by the cutting device, foliage to be cut, and cutting off the foliage;
S6, disinfecting a cutting blade and a pruned cut by operation of a water pump of a disinfection device; and
S7, moving the cutting device to a position above the collecting frame by rotating the rotation support body from side to side and swinging the telescopic arm base up and down, and through the extension and retraction of the telescopic shaft, and releasing the cutting device to allow cut old leaves fall into the collecting frame.

11. The leaf removal method according to claim 10, wherein the tomato leaf removal robot for facilities further comprises a disinfection device, wherein the disinfection device comprises a water tank, a water pump, and a disinfection spray head mounted on the cutting device.

12. The leaf removal method according to claim 11, wherein an outlet of the water pump communicates with the disinfection spray head through a retractable spring water hose.

13. The leaf removal method according to claim 10, wherein the cutting device comprises:
a housing, fixedly connected to the front end of the telescopic shaft;
two gears, rotatably connected to the housing and meshed with each other;
two blade support members, slidingly connected to the housing along arrangement directions of the two gears; and
a fourth motor, for driving any one of the two gears to rotate, wherein
each blade support member is fixedly connected with a cutting blade,
the two gears are fixedly connected with a first clamping finger and a second clamping finger, respectively, and
each blade support member is fixedly connected with a rack meshed with a corresponding gear.

14. The leaf removal method according to claim 10, wherein the telescopic shaft comprises:
a tubular outer casing;
a first telescopic tube, slidably fitted within the outer casing in the front-back direction;
a second telescopic tube, slidably fitted within the first telescopic tube in the front-back direction;
a second lead screw;
a first lead screw, slidably fitted within the second lead screw in the front-back direction; and
a third motor, for driving the first lead screw to rotate, wherein
a rear end of the second lead screw is rotatably connected with a first drive ring fixedly connected to the first telescopic tube,
the first drive ring is in threaded connection with the first lead screw, and
the second lead screw is in threaded connection with a second drive ring fixedly connected to the second telescopic tube.

15. The leaf removal method according to claim 14, wherein the third motor is configured to drive a rotation platform of a rotation driving platform to rotate, and the first lead screw is connected to the rotation platform.

16. The leaf removal method according to claim 10, wherein the rotation support body is connected to an upper end face of the walking body through a bottom rotation platform, and the telescopic arm base is connected to the rotation support body through a side rotation platform.

17. The leaf removal method according to claim 10, wherein the collecting frame comprises:
an outer plate of the collecting frame, located on a side surface of the walking body;
a retractable plate, in sliding fit with the walking body in a horizontal direction; and
a driver, for driving the retractable plate to slide horizontally, wherein
the outer plate of the collecting frame is fixedly connected to the retractable plate, and
elastic cloths are connected between both sides and a lower end of the outer plate of the collecting frame and the walking body.

18. The leaf removal method according to claim 10, wherein walking mechanisms are mounted on both sides at bottom of the walking body, and each walking mechanism comprises a track wheel assembly and a land wheel assembly; wherein
the track wheel assembly comprises a track driven wheel and a track driving wheel;
the land wheel assembly comprises a first universal wheel, a land wheel and a second universal wheel; and
the track wheel assembly and the land wheel assembly are staggered in a left-right direction, and a lower end of the track wheel assembly is higher than that of the land wheel assembly.
